(19) United States
(12) Patent Application Publication
(10) Pub. No.: US 2012/0175203 A1
(43) Pub. Date: Jul. 12, 2012

(54) Brake Cooling Fan and Method of Use

(76) Inventor: Jerry Robertson, Lakewood, CO (US)

(21) Appl. No.: 12/986,976

(22) Filed: Jan. 7, 2011

(51) Int. Cl. F16D 65/847; B23P 11/00

(52) U.S. Cl. 188/264 A; 29/428

(57) ABSTRACT

A brake-cooling device is provided for a motor vehicle having a wheel with a wheel hub, and a disc brake assembly. The brake-cooling device consists of a first fan blade with blade leaves that move air while the first fan blade is in motion. The first fan blade is secured onto the wheel hub on an outside-facing side of the wheel hub. Because the brake-cooling device is positioned on the outside-facing side of the wheel hub (rather than within the disc brake assembly, for example), the brake-cooling device can be readily removed or replaced as necessary. The present invention is also designed such that the first fan blade can be stacked with additional fan blades or with other wheel accessories without interfering with the operation of the wheel (e.g., some embodiments of the invention does not require the wheel offsets to be changed) or disc brake assembly.

### FIELD OF THE INVENTION

The invention relates to a technology for cooling motor vehicle wheels equipped with disc brakes.

### BACKGROUND OF THE INVENTION

It is well known in the automotive brake art to use devices such as ventilated brake rotors, fan blades, and specialty wheel trims to improve the heat transfer to the ambient air.

During the conventional operation of motor vehicle brakes, heat is generated in the brake rotor as the kinetic energy of the moving vehicle is converted to heat energy as brake pads are applied to the brake rotor. The buildup of heat in the brake rotor can lead to unequal temperature distribution in the brake rotor, causing it to warp and deteriorate.

A complication associated with this buildup of heat is that the heated air surrounding the brake rotor decreases the vehicle's aerodynamics. Given its location in the undercarriage of the vehicle, the brake rotor (and its associated wheel assembly) creates a high-pressure air pocket underneath the vehicle, resulting in significant drag. Because the air around the brake rotor is warmer than the ambient temperature, the heated air tends to stagnate above and behind the wheel assembly, thus requiring specialized outlets for ventilation in order to reduce drag.

However, the more serious concern resulting from overheating brake rotors is that the braking surfaces experience a reduction in stopping power as temperature rises. The loss in stopping power, also known as brake fade, occurs most often during high performance driving and during long steep downhill routes where large trucks are constantly applying the brakes.

The prior art has attempted to overcome these problems in a variety of ways, usually using a combination of the following devices to assist in brake cooling. One category of prior art solutions is to blast cooler air onto the brake rotor. Brake ducts are commonly placed in the front of the vehicle to generate this stream of air. However, this worsens the problem with respect to aerodynamics.

Another prior art innovation was to ventilate the brake rotor itself. Like the brake ducts above, this prior art innovation assists in the cooling of the brakes, but only complicates the aerodynamics problem since the air vented from the brake rotor is simply pushed into the high-pressure air pocket around the wheel assembly.

Recognizing this problem, manufacturers have created brake vents typically located above and behind the wheel to help eliminate the high-pressure air pocket. The combination of the brake ducts, the ventilated brake rotors, and the brake vents generally resolve the brake fade issue. However, these devices are structurally integrated into the vehicle and cannot be readily and significantly changed. For example, in order to safely change the brake rotors, the vehicle must be taken into the garage and lifted by a jack stand.

Adjustments to the brake ducts and the brake vents can be made by simply taping the openings of these channels. However, such changes to the brake cooling system are rudimentary and extremely limited. To adjust the airflow patterns via these channels, the vehicle must again be taken into the garage since the car body shell must be removed in order to access and/or change the brake ducts and the brake vents.

The prior art also teaches the use of wheels and wheel accessories (particularly wheel trims, hubcaps, and wheel fairings) to ventilate the brake unit. Each of these has significant limitations. One common limitation among these wheel-related brake-cooling devices is that the airflow generated by these devices is limited to an outwardly direction perpendicular to the wheel. In other words, these wheel-related devices make no use of the brake vent system. Wheel-related devices are also not stackable. For all practical purposes, a vehicle cannot support more than one wheel on a wheel hub or support more than one wheel accessory on a wheel.

Also, the wheel accessories (and the wheels to a lesser extent) are relatively inefficient at drawing the air away from the brake rotor because of the gap distance and the structural obstructions (i.e., the wheel itself) between the brake rotor and the wheel accessories. Therefore, wheel accessories merely draw out the air from the wheel assembly area without actively pushing the air out.

Having a vented and/or a fan-like wheel is raises other considerations. First, wheels are limited in size and specification because 1) they must fit within the space provided by the car body shell, 2) they must be compatible with the bolt patterns on the wheel hub, and 3) they must support specifically sized tires. Wheel rims are also relatively expensive and difficult to manufacture in a short amount of time.

Accordingly, there is a need for a relatively inexpensive yet efficient brake-cooling system that is adjustable and readily accessible. Such a brake-cooling system should be particularly suited for racing and high performance driving.

### SUMMARY OF THE INVENTION

In accordance with the present invention, a brake-cooling device is provided for a motor vehicle having a wheel with a wheel hub, and a disc brake assembly. The brake-cooling device consists of a first fan blade with blade leaves that move air while the first fan blade is in motion. The first fan blade is secured onto the wheel hub on an outside-facing side of the wheel hub. Because the brake-cooling device is positioned on the outside-facing side of the wheel hub (rather than within the disc brake assembly, for example), the brake-cooling device can be readily removed or replaced as necessary. The present invention is also designed such that the first fan blade can be stacked with additional fan blades or with other wheel accessories without interfering with the operation of the wheel (e.g., some embodiments of the invention does not require the wheel offsets to be changed) or disc brake assembly.

The flexibility provided by the present invention allows rapid adjustments to a brake cooling system, which can be vital for time-pressure situations such as high-performance racing. For example, a brake duct can suffer a blockage during a race, creating an unequal temperature distribution of a brake rotor. Under those circumstances, the first fan blade or additional fan blades (if the first fan blade is already installed) can be inserted on the wheel hub to divert airflow back to the brake rotor. The first fan blade can also be altered, removed, or replaced as the need arises.

In addition, since the cooling device is located on the easily accessible wheel hub, adjustments to the cooling device (e.g., adding, removing, or replacing fan blades) can be made without heavy equipment. This means that the cooling device can be adjusted even in the remote locations and the harsh conditions frequently encountered by truck drivers. The present invention thus allows truck drivers to make changes to the cooling device just before reaching steep downgrades, even if there are no service garages in that area.

Another feature of the present invention is that the fan blades are stackable, meaning that multiple fan blades can be installed on the same wheel hub and used to cool the brake rotor.

With this feature, drivers can install fan blades that divert airflow in different directions without having to make any significant structural changes. With this feature, drivers are provided the option to balance the advantages of increase brake cooling against the disadvantage of added weight. This balance is critical in high performance driving.

Other objects, features and advantages of the present invention will become apparent to those skilled in the art from the drawings, detailed description and claims which follow.

### BRIEF DESCRIPTION OF THE DRAWINGS

FIG. 1 is a side view of an embodiment of the present invention.

FIG. 2 is a perspective view of an embodiment of the present invention.

FIG. 3 is a front view of a fan blade used as part of an embodiment of the present invention.

FIG. 4 is a front view of an embodiment of the present invention with the wheel in place.

FIG. 5 is a rear view of an embodiment of the present invention with the wheel in place.

FIG. 6 is a rear view of an embodiment of the present invention showing two stacked fan blades with the wheel in place.

### DETAILED DESCRIPTION OF THE INVENTION

In a motor vehicle, the brake rotor 210 generates and accumulates heat during the operation of the brakes (not shown). To dispel this heat, cool air is typically blasted at the brake rotor 210 using devices such as brake ducts (not shown). The heat is transferred from the brake rotor 210 to the cool air and the resulting warm air is expelled away from the brake rotor 210.

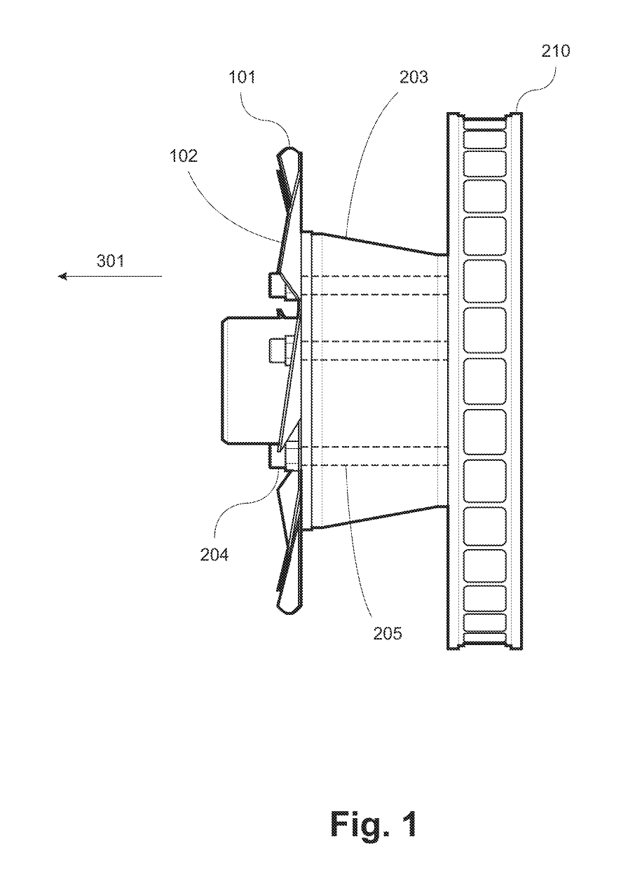

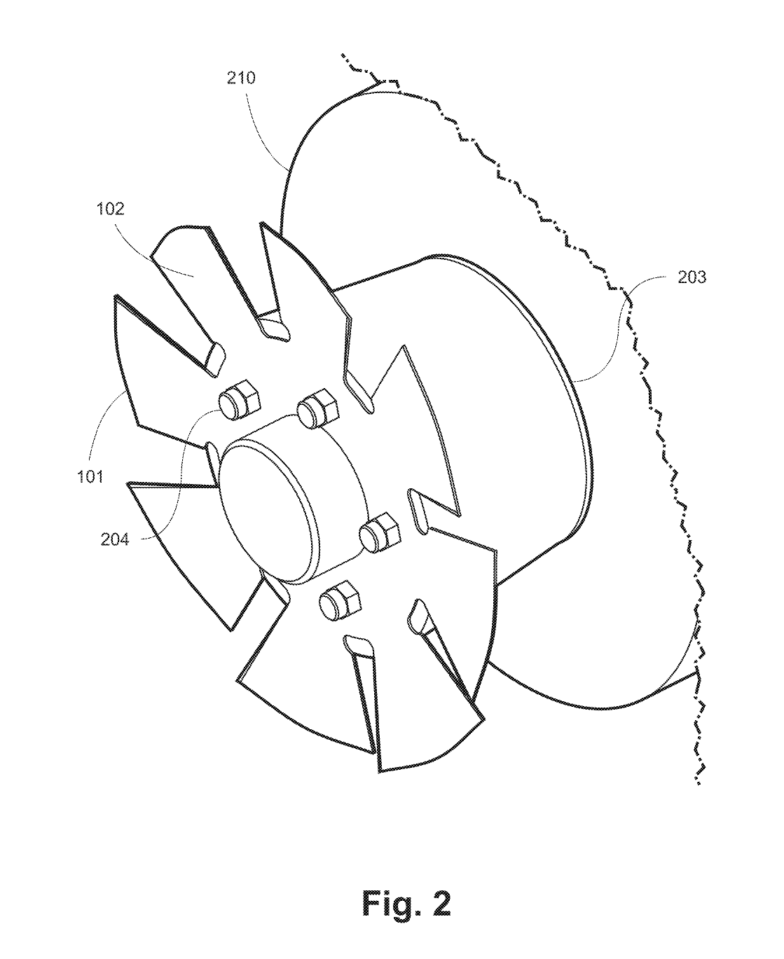

FIG. 1 and FIG. 2 show the fan blade 101 that is used as part of an embodiment of the present invention. The fan blade 101, the wheel hub 203, and the brake rotor 210 are secured together by lug nuts 204 and wheel bolts 205. On an operational motor vehicle, the wheel (not shown) would also secured by the lug nuts 204 and the wheel bolts 205 on the outer side of the fan blade 101, opposite the wheel hub 203. During operation of the motor vehicle, the fan blade 101 turns as the wheel turns. As the fan blade 101 turns, the blade leaves 102 of the fan blade 101 force the warm air outward in a direction 301 generally perpendicular to and away from the fan blade 101.

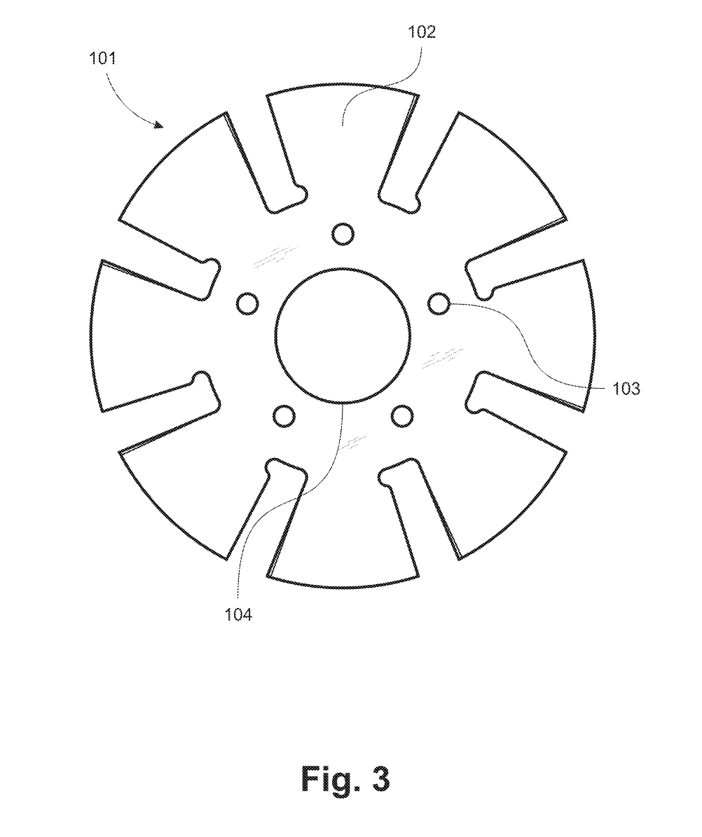

FIG. 3 shows a typical fan blade 101 according to an embodiment of the present invention. Under typical conditions, the fan blade 101 is designed to draw air around the brake rotor and then to expel that air outwardly. However, the fan blade 101 and the blade leaves 102 can also be designed to expel air radially or in other directions (e.g., toward brake cooling vents) depending on the circumstances. The fan blade 101 has a center bore hole 104 and bolt holes 103 to secure the fan blade 101 onto the wheel hub 203 and the wheel bolts 205, respectively.

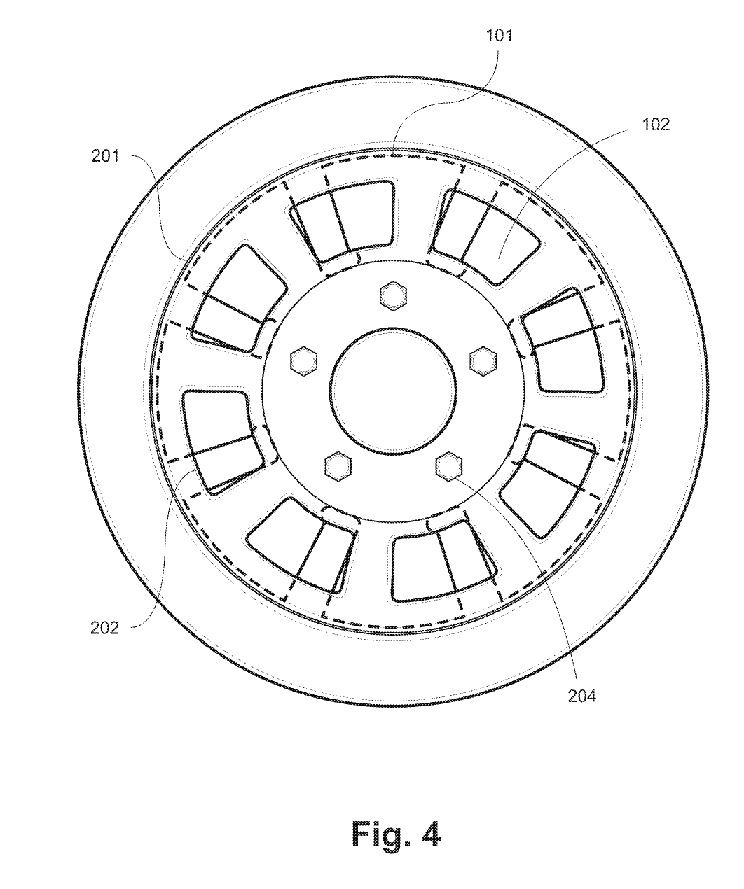

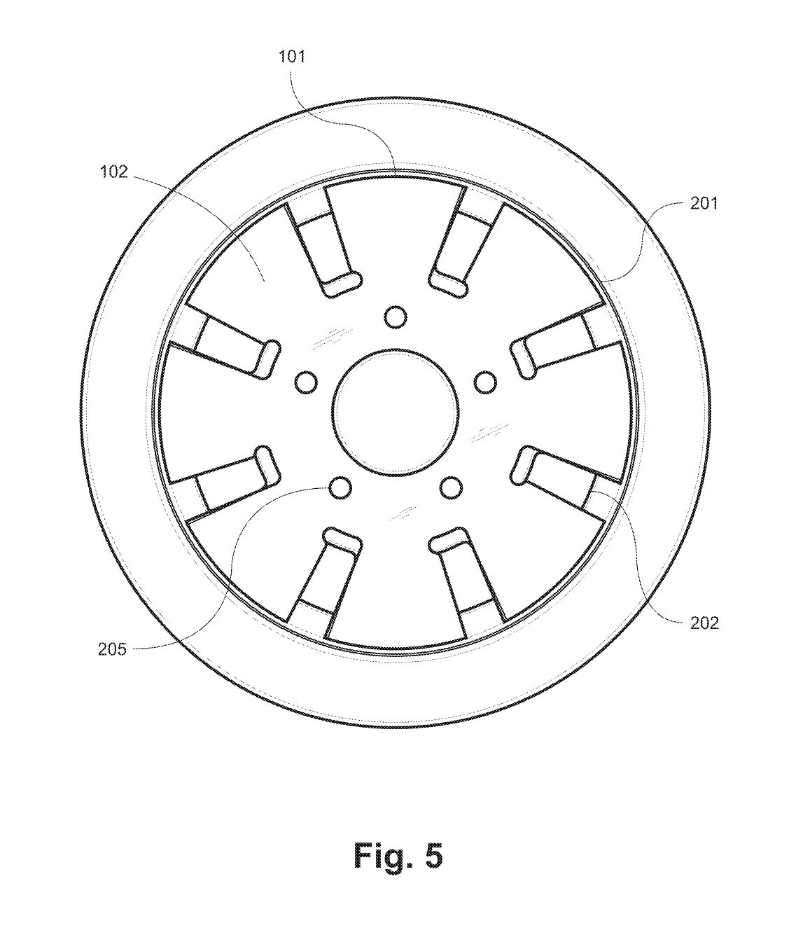

FIG. 4 and FIG. 5 show the fan blade 101 being positioned on the inner side of the wheel 201. According to an embodiment of the present invention, the blade leaves 102 push the warm air outwardly through wheel vents 202, thereby cooling the brake rotor 210. This diversion of air also reduces air pressure from underneath the motor vehicle, thereby increasing down force and improving aerodynamics.

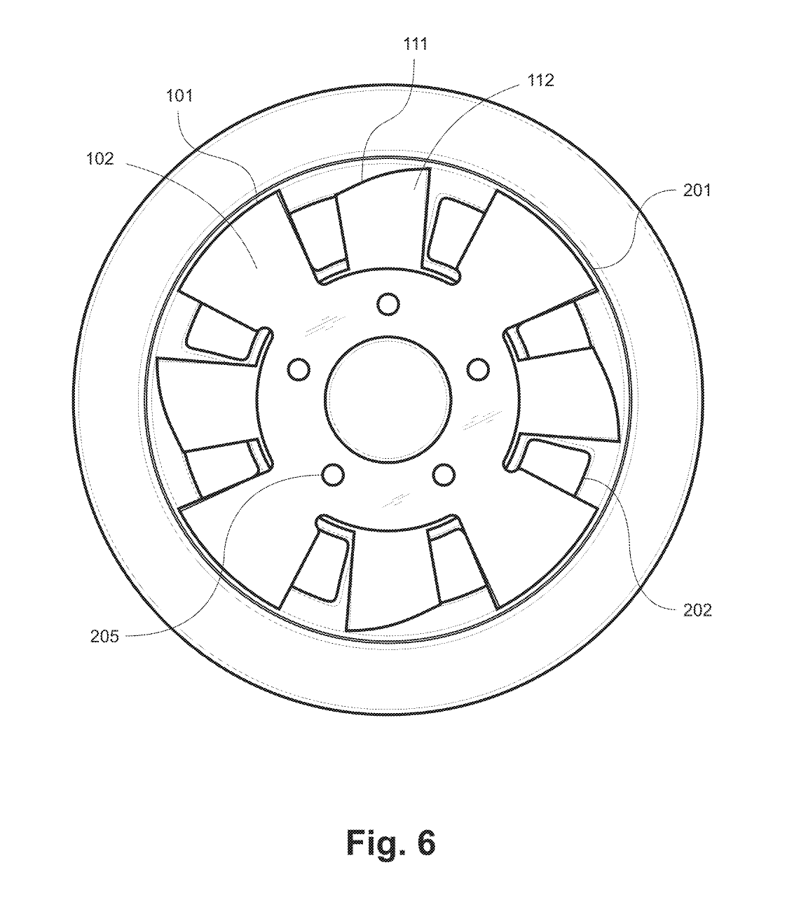

The present invention is designed for flexibility, allowing adjustments to the cooling device as the need arises. Consistent with that objective is an embodiment shown in FIG. 6, where the fan blade 101 is used in conjunction with a second fan blade 111. The fan blade 101, the second fan blade 111, and the wheel 201 are all secured onto the wheel hub 203 and the brake rotor using lug nuts 204 and wheel bolts 205.

It is particularly advantageous to use the present invention for racing. During a race, it can be determined that adjustments to the brake cooling system need to be made. For example, a driver sensing performance anomalies can communicate to his pit crew the need to adjust the brake cooling system. Alternatively, the pit crew or other observers can gauge the need for an adjustment based on remotely accessed instrumental data or other observations. The pit crew can then decide, while the driver is still out in the field, whether to use prefabricated fan blades or to construct new fan blades. The driver can then make a pit stop as appropriate.

During the pit stop, the pit crew jacks up the vehicle and removes the wheel. Based on their strategy, the pit crew can remove, replace, and/or add to the first fan blade (if one was previously installed) to adjust the brake cooling system. This process does not require the wheel hub or the brake rotor to be repositioned or removed. If further adjustments or enhancements to the brake cooling system is desired, this procedure can be repeated.

What is claimed is:

1. A brake cooling system for a motor vehicle equipped with a wheel, a wheel hub, and a brake rotor, comprising:
a first fan blade with at least one blade leaf capable of directing airflow;
said first fan blade positioned between said wheel and said wheel hub;
said first fan blade secured with a wheel bolt to said wheel hub and to said brake rotor;
wherein said first fan blade is removable from said motor vehicle without requiring repositioning of said wheel hub or said brake rotor.

2. The brake cooling system of claim 1, wherein said blade leaf directs said airflow in a direction generally perpendicular to and away from said brake rotor.

3. The brake cooling system of claim 1, wherein said first fan blade does not affect the offset of the wheel.

4. The brake cooling system of claim 3, wherein said blade leaf directs said airflow in a direction generally perpendicular to and away from said brake rotor.

5. The brake cooling system of claim 1, further comprising:
a second fan blade with at least one second fan blade leaf capable of directing airflow;
said second fan blade positioned between said first fan blade and said wheel hub;
said second fan blade secured with said wheel bolt to said wheel hub and to said brake rotor;
wherein said second fan blade is removable from said motor vehicle without requiring repositioning of said wheel hub or said brake rotor.

6. The brake cooling system of claim 5, wherein said second fan blade leaf directs said airflow in a direction generally perpendicular to and away from said brake rotor.

7. The brake cooling system of claim 5, wherein said second fan blade does not affect the offset of the wheel.

8. The brake cooling system of claim 7, wherein said second fan blade leaf directs said airflow in a direction generally perpendicular to and away from said brake rotor.

9. The brake cooling system of claim 7, wherein said second fan blade leaf directs said airflow in a direction generally parallel to said brake rotor.

10. The brake cooling system of claim 7, wherein said second fan blade leaf directs said airflow in a direction generally perpendicular to and toward said brake rotor.

11. A method for cooling a brake rotor, said brake rotor located adjacent to a wheel hub, said wheel hub having an outer side opposite the side facing said brake rotor, comprising:
installing a first fan blade on said outer side of said wheel hub without requiring the repositioning of said wheel hub or said brake rotor;
securing said first fan blade with a wheel bolt to said wheel hub and to said brake rotor;
installing a wheel on an outer side of said first fan blade opposite the side facing said wheel hub;
generating airflow on a surface of said brake rotor by spinning said first fan blade.

12. The method for brake cooling of claim 11, further comprising:
generating airflow in a direction generally perpendicular to and away from said brake rotor.

13. The method for brake cooling of claim 11, wherein installing said first fan blade on said outer side of said wheel hub does not affect the offset of said wheel.

14. The method for brake cooling of claim 11, further comprising:
installing a second fan blade between said first fan blade and said wheel hub without requiring the repositioning of said wheel hub or said brake rotor;
securing said second fan blade with said wheel bolt to said wheel hub and to said brake rotor;
generating airflow on a surface of said brake rotor by spinning said second fan blade.

15. The method for brake cooling of claim 14, further comprising:
generating airflow in a direction generally perpendicular to and away from said brake rotor.

16. The method for brake cooling of claim 15, wherein installing said first fan blade on said outer side of said wheel hub does not affect the offset of said wheel.

17. A method for enhancing a brake cooling system of a race car during an auto race, said race car having a brake rotor, said brake rotor located adjacent to a wheel hub, said wheel hub having an outer side opposite the side facing said brake rotor, comprising:
determining that said brake cooling system requires enhancement by a race car driver or other observer monitoring the behavior of said brake cooling system during said race;
installing during a pit stop a first fan blade on said outer side of said wheel hub;
installing a wheel on an outer side of said first fan blade opposite the side facing said wheel hub;
returning said race car to said race.

18. The method for enhancing a brake cooling system of claim 17, wherein installing said first fan blade can be done without requiring the removal of said wheel hub or said brake rotor.

19. The method for enhancing a brake cooling system of claim 17, further comprising:
determining if additional enhancement to said brake cooling system is desired by said race car driver or other observer monitoring the behavior of said brake cooling system after installation of said first fan blade;
returning for a follow up pit stop if additional enhancement is desired by said race car driver or other observer;
adding a second fan blade during said follow up pit stop in a position adjacent to said first fan blade; and
returning said race car to said race.

20. The method for enhancing a brake cooling system of claim 19, wherein installing said first fan blade and adding said second fan blade can be done without requiring the removal of said wheel hub or said brake rotor.
